(19) United States
(12) Patent Application Publication
(10) Pub. No.: US 2026/0243872 A1
(43) Pub. Date: Aug. 20, 2026

(54) RANGING DEVICE, SWITCH DEVICE, AND CONTROL CHIP

(71) Applicant: Asahi Kasei Microdevices Corporation, Tokyo (JP)

(72) Inventors: Shinichi TAMAKI, Tokyo (JP); Hiroyuki NISHIMUTA, Tokyo (JP); Yusuke HARADA, Tokyo (JP)

(21) Appl. No.: 19/420,785

(22) Filed: Dec. 16, 2025

(30) Foreign Application Priority Data
Dec. 19, 2024 (JP) 2024-224479
Oct. 31, 2025 (JP) 2025-184505

(51) Int. Cl. G01S 7/484; G01S 7/481; G01S 7/4863; G01S 17/10

(52) U.S. Cl. CPC G01S 7/484; G01S 7/4815; G01S 7/4863; G01S 17/10

(57) ABSTRACT

Provided is a ranging device comprising a light-emitting unit, a light-receiving unit, and a control unit having a storage area. The control unit is configured to be able to send and/or receive a state signal indicating the state of the light-receiving unit to and/or from the light-receiving unit. The state signal includes information indicating whether or not the light-receiving unit is in a state where it can measure light from the target or information for enabling the light-receiving unit to measure the light. The control unit outputs the channel select signal and the light emission control signal to the light-emitting unit in response to the state signal stored in the storage area. The light-emitting unit is configured to receive the state signal from the light-receiving unit or the control unit as input.

The contents of the following patent application(s) are incorporated herein by reference:

NO. 2024-224479 filed in JP on Dec. 19, 2024 and

NO. 2025-184505 filed in JP on Oct. 31, 2025.

### BACKGROUND

### 1. Technical Field

The present invention relates to a ranging device, a switch device, and a control chip.

### 2. Related Art

Patent Document 1 discloses “a laser array driven circuit” that is “applied to a distance detection device”. Patent Document 2 discloses “a depth acquisition unit” including “a laser driver array” and “a laser array”.

### RELATED ART DOCUMENTS

### Patent Documents

Patent Document 1: U.S. Pat. No. 7,809,037.

Patent Document 2: Japanese translation publication of a PCT route patent application No. 2023-517000.

### BRIEF DESCRIPTION OF THE DRAWINGS

FIG. 1 is a diagram showing a configuration example of a ranging device 100 according to one embodiment of the present invention.

FIG. 2 is a timing chart showing a waveform example of each signal.

FIG. 3 is a diagram showing one example of a ranging device 200 according to a comparative example.

FIG. 4 is a timing chart showing a waveform example of each signal in the ranging device 200.

FIG. 5 is a diagram showing a cause of variation in the delay time of a light emission pulse signal LP and a channel select signal CH in the ranging device 200 according to the comparative example and in the ranging device 100 according to a working example.

FIG. 6 is a diagram showing a configuration example of a light-receiving unit 60 and a pulse generation circuit 30.

FIG. 7 is a timing chart describing an operation example of the light-receiving unit 60 and the pulse generation circuit 30 shown in FIG. 6.

FIG. 8 is a diagram showing another configuration example of the ranging device 100.

FIG. 9 is a diagram showing another configuration example of the ranging device 100.

FIG. 10 is a timing chart showing a waveform example of each signal in the example shown in FIG. 9.

FIG. 11 is a diagram showing a cause of variation in the delay time of the light emission pulse signal LP and the channel select signal CH in the ranging device 100 according to the example of FIG. 9.

FIG. 12 is a diagram showing a configuration example of the light-receiving unit 60 and the pulse generation circuit 30 in the example of FIG. 9.

FIG. 13 is a timing chart showing a waveform example of each signal in the example shown in FIG. 12.

FIG. 14 is a diagram showing another configuration example of the ranging device 100.

FIG. 15 is a diagram showing another configuration example of the control unit 10.

FIG. 16 is a diagram showing a configuration example of the switch device 80.

FIG. 17 is a timing chart describing another operation example of the switch device 80.

FIG. 18 is a diagram showing another configuration example of the pulse generation circuit 30.

FIG. 19 is a diagram showing a configuration example where a power supply circuit 110 for supplying power supply voltage to the light-emitting unit 70 and the electric power source control unit 120 are provided.

FIG. 20 is a diagram showing a configuration example of the electric power source control unit 120.

FIG. 21 is a diagram showing another configuration example of the switch device 80.

### DESCRIPTION OF EXEMPLARY EMBODIMENTS

Hereinafter, the present invention will be described through embodiments of the invention, but the following embodiments do not limit the invention according to the claims. Further, not all of combinations of features described in the embodiments are essential to the solving means of the invention.

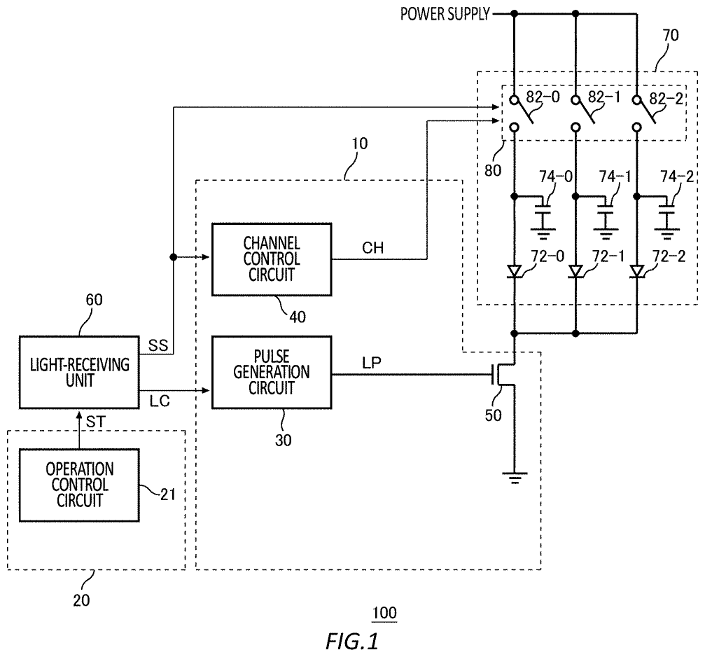

FIG. 1 is a diagram showing a configuration example of a ranging device 100 according to one embodiment of the present invention. The ranging device 100 emits light to a target and then measures the distance L (m) to the target based on the time T (s) it takes to receive reflected light from the target. For example, when it is assumed that the speed of light is c (m/s), the distance L is given by the following formula:

L=cT/2.

The ranging device 100 in the present example can measure the distance to each portion of the target in a predetermined angle of view by using a plurality of light-emitting elements, each of which emits light in a different direction. Each of the light-emitting elements is caused to emit light sequentially to measure the reflected light, so that a control system and a measurement system for the plurality of light-emitting elements can be shared, and the ranging device 100 can be made smaller.

The ranging device 100 in the present example includes a light-emitting unit 70, a light-receiving unit 60, a control unit 10, and an MCU (Micro Controller Unit) unit 20. The light-emitting unit 70 has a plurality of light-emitting elements 72 that emit light to a target. Although the example of FIG. 1 shows three light-emitting elements 72-0, 72-1, and 72-2, the light-emitting unit 70 may have more light-emitting elements 72 or may have two light-emitting elements 72. Each of the light-emitting elements 72 may be, for example, a laser diode, but is not limited thereto. Each of the light-emitting elements 72 may emit light in mutually different directions. The plurality of light-emitting elements 72 may be arranged in a row along one direction or may be arranged in rows along a plurality of directions. For example, the plurality of light-emitting elements 72 may be arranged in a predetermined interval in a predetermined plane or curved surface.

The light-receiving unit 60 receives light from the target. The light-receiving unit 60 receives reflected light, which is the light emitted by the light-emitting unit 70 and then reflected by the target. The light-receiving unit 60 may be provided in common for the plurality of light-emitting elements 72. The light-receiving unit 60 measures, for each light-emitting element 72, the time T between the light-emitting element 72 emitting light and the light-receiving unit 60 receiving the reflected light from the target. This enables the distance to the target to be measured in the direction in which each of the light-emitting elements 72 emits light.

The light-emitting unit 70 in the present example has a switch device 80 including a plurality of switches 82, and a plurality of charge capacitors 74. The plurality of switches 82 and the plurality of charge capacitors 74 are provided to correspond to the plurality of light-emitting elements 72. That is, the switch 82 is provided in one-to-one correspondence with the light-emitting element 72, and the charge capacitor 74 is also provided in one-to-one correspondence with the light-emitting element 72. In the present example, the configuration including one switch 82, one charge capacitor 74, and one light-emitting element 72 may be referred to as a channel. In each channel, the switch 82 and the light-emitting element 72 are provided in series between a power supply and a reference potential (for example, ground potential). In the example of FIG. 1, the switch 82 is arranged on the higher potential side than the light-emitting element 72. The charge capacitor 74 is provided between the anode terminal of the light-emitting element 72 and the reference potential.

Among the plurality of switches 82, the switch 82 corresponding to the channel select signal CH described below is controlled to switch to the ON state. When any of the switches 82 is controlled to switch to the ON state, the corresponding light-emitting element 72 is connected to the power supply and becomes able to emit light. In the present specification, the state where the corresponding switch 82 is in the ON state may be referred to as being able to emit light. In addition, when any of the switches 82 is controlled to switch to the ON state, the corresponding charge capacitor 74 is charged by the power supply. The power supply may be a power supply provided in the ranging device 100 or may be an external power supply.

In the present example, the cathode terminal of each of the light-emitting elements 72 is connected to a common driver 50. The driver 50 in the present example is an Si MOS transistor. The driver 50 may be a transistor formed of a chemical semiconductor such as GaN or SiC. When the driver 50 switches to the ON state, the cathode terminal of each light-emitting element 72 is connected to the reference potential. When the driver 50 switches to the ON state, the light-emitting element 72 capable of emitting light whose corresponding switch 82 is in the ON state emits light. When the charge capacitor 74 is precharged before the driver 50 switches to the ON state, the period between the driver 50 being controlled to switch to the ON state and the light-emitting element 72 actually emitting light can be reduced.

In the configuration as shown in FIG. 1, it is preferable to precisely synchronize the timing to control the switch 82 to switch to the ON state and the timing to control the driver 50 to switch to the ON state. For example, when the timing to control the switch 82 to switch to the ON state is delayed, the electric charge charged on the charge capacitor 74 is not enough. As a result, the light-emitting element 72 may not emit light or the light emission intensity may be insufficient even if the driver 50 is controlled to switch to the ON state. In addition, when the timing to control the driver 50 to switch to the ON state is delayed, the period when the light-emitting element 72 emits light may be shorter. In the present specification, causing two signals to have a predetermined phase difference is referred to as synchronization. That is, the synchronization refers not only to the case where the edge timings of the two signals coincide but also to the case where the edge timings of the two signals have a predetermined time difference.

The control unit 10 in the present example precisely synchronizes the timing to control the switch 82 to switch to the ON state and the timing to control the driver 50 to switch to the ON state. In this way, for example, even if the periodicity for switching the channel in the light-emitting unit 70 is made shorter, the light-emitting element 72 can precisely emit light, and the distance to the target can be measured at high speed. Thus, for example, the ranging device 100 in the present example is also suitable to real-time ranging.

The control unit 10 controls the light-emitting unit 70. The control unit 10 controls the timing when the light-emitting unit 70 emits light. For example, the control unit 10 controls each timing such that each light-emitting element 72 emits light during a period when the light-receiving unit 60 can receive reflected light.

The control unit 10 in the present example has a pulse generation circuit 30, a channel control circuit 40, and the driver 50. The MCU unit 20 may be, for example, a microcomputer. The MCU unit 20 may be provided in a circuit chip independent from the control unit 10. The MCU unit 20 in the present example functions as an operation control circuit 21 and outputs an operation instruction signal ST which determines the timing of the ranging by each channel of the light-emitting unit 70. The MCU unit 20 is configured to control the light-receiving unit 60 and controls the timing when the light-receiving unit 60 becomes able to receive reflected light. The MCU unit 20 in the present example outputs the operation instruction signal ST to the light-receiving unit 60.

In response to the operation instruction signal ST, the light-receiving unit 60 is controlled to switch to the state where it can receive reflected light. For example, in response to the operation instruction signal ST, the light-receiving unit 60 resets the amount of the electric charge accumulated by a light-receiving element such as a photodiode through photoelectric conversion during a previous scan period, enabling photoelectric conversion during the next scan period.

The light-receiving unit 60 in the present example generates and outputs the scan start signal SS indicating whether or not the light-receiving unit 60 is in a state where it can receive the reflected light. The light-receiving unit 60 in the present example inputs the scan start signal SS to both the light-emitting unit 70 and the control unit 10.

For example, the scan start signal SS is a binary signal exhibiting H logic when the light-receiving unit 60 is in a state where it can receive the reflected light, and exhibiting L logic when it is in a state where it cannot receive the reflected light. The scan start signal SS in the present example is a signal where the periods of H logic and the periods of L logic are repeated. A single repetition of H logic and L logic in the scan start signal SS corresponds to ranging by a single channel. For example, the light-receiving unit 60 performs photoelectric conversion in the ranging of the channel during the period of H logic of the scan start signal SS and performs a reset of the electric charge during the next period of L logic, and performs photoelectric conversion in the ranging of the next channel during the next period of H logic. Through such repetition of operations, the light-receiving unit 60 performs ranging for each channel.

The channel control circuit 40 in the present example generates the channel select signal CH synchronously with the scan start signal SS. The channel select signal CH is a signal for specifying the light-emitting element 72 that is to emit light next. The channel control circuit 40 has preset information indicating the order to select the light-emitting elements 72. For example, when the light-emitting unit 70 has a zeroth channel to an nth channel, the channel control circuit 40 may select each channel from zeroth to nth channel in ascending order of number. In addition, the zeroth channel may be selected following the nth channel. However, the order to select channels is not limited thereto.

The light-emitting unit 70 is configured to receive the state signal from the light-receiving unit 60 or the control unit 10 as input. The light-emitting unit 70 in the present example receives the scan start signal SS from the light-receiving unit 60 and receives the channel select signal CH from the channel control circuit 40. The switch device 80 in the present example controls each switch 82 based on the scan start signal SS and the channel select signal CH. For example, the switch device 80 controls the switch 82 of the channel specified by the channel select signal CH to switch to the ON state during a period when the scan start signal SS exhibits H logic. In this way, the charge capacitor 74 of the channel is charged and the voltage of the charge capacitor 74 is applied to the light-emitting element 72 of the channel.

The light-receiving unit 60 in the present example further outputs the light emission instruction signal LC that causes the light-emitting element 72 to emit light. The light emission instruction signal LC is a signal synchronized with the scan start signal SS. For example, the light emission instruction signal LC is a binary signal which transitions to H logic at the timing when the light-emitting element 72 should emit light. The light-receiving unit 60 may cause the logic value of the light emission instruction signal LC to transition to H logic in response to the light-receiving unit 60 switching to a state where it can receive the reflected light. In this way, the light-emitting element 72 can be caused to emit light during the period when the light-receiving unit 60 can receive light.

In response to the light emission instruction signal LC, the pulse generation circuit 30 generates the pulse signal LP including the pulse with a predetermined pulse width. The pulse generation circuit 30 in the present example generates the pulse with the predetermined pulse width at the timing when the light emission instruction signal LC transitions to H logic. The pulse width is preset by the manufacturer, user, or the like of the ranging device 100. The pulse width corresponds to a single light emission period of the light-emitting element 72.

The driver 50 is provided in common for the plurality of light-emitting elements 72. In response to the pulse signal LP corresponding to the light emission control signal (the light emission instruction signal LC in the present example), the driver 50 causes any of the light-emitting elements 72 to emit light. The driver 50 in the present example is an MOSFET where the pulse signal LP is input to the gate terminal. For example, during the period when the pulse signal LP exhibits H logic, the driver 50 is in the ON state and connects the cathode terminals of the plurality of light-emitting elements 72 to the reference potential. In this way, the light-emitting element 72 whose corresponding switch 82 is in the ON state emits light.

The control unit 10 in the present example is configured to be able to communicate with the light-emitting unit 70 and the light-receiving unit 60 and has the storage area 39 described below. “Being able to communicate” refers to being able to perform at least one of transmitting or receiving information. For example, the control unit 10 is configured to be able to send and/or receive the state signal indicating the state of the light-receiving unit 60 to and/or from the light-receiving unit 60. The control unit 10 may receive the state signal from the light-receiving unit 60 or may transmit the state signal to the light-receiving unit 60. In any case, the control unit 10 is in a state of being able to recognize the state of the light-receiving unit 60. The control unit 10 may recognize whether the light-receiving unit 60 is in any of the following states: the state where it can receive light or the state where it is controlled to switch to the state where it can receive light, or whether it is in neither state. In the present example, the control unit 10 recognizes the state of the light-receiving unit 60 as a result of the state signal being stored in the storage area 39.

Based on at least one of the state signal indicating the state of the light-receiving unit 60 or the light emission control signal controlling the light emission timing of the light-emitting unit 70, the control unit 10 in the present example generates the channel select signal CH for selecting the light-emitting element 72 that is to emit light at the light emission timing depending on the light emission control signal. The state signal is a signal including the information indicating whether or not the light-receiving unit 60 is in a state where it can measure light from the target or the information for enabling the light-receiving unit 60 to measure the light. In the present example, the scan start signal SS indicating whether or not the light-receiving unit 60 is in a state where it can receive reflected light is one example of the state signal. In addition, the light emission instruction signal LC is one example of the light emission control signal.

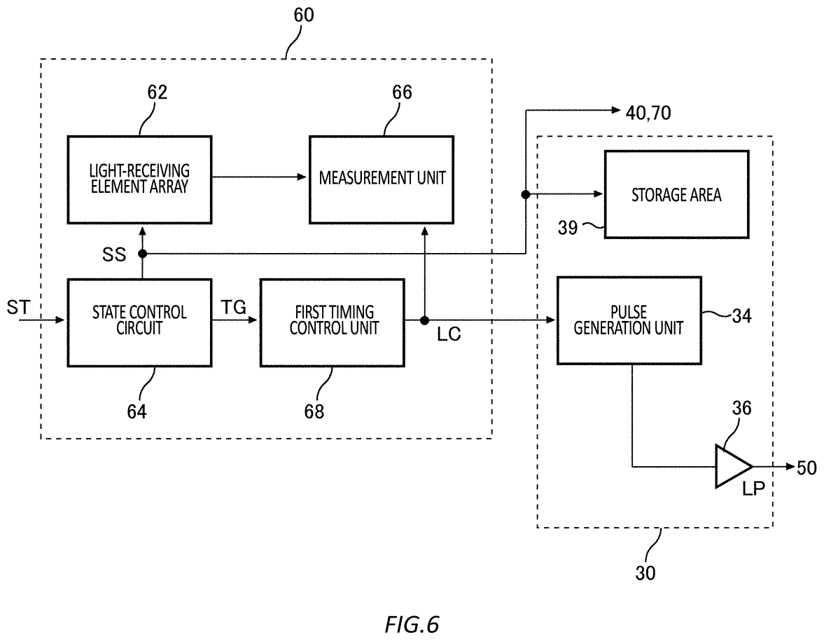

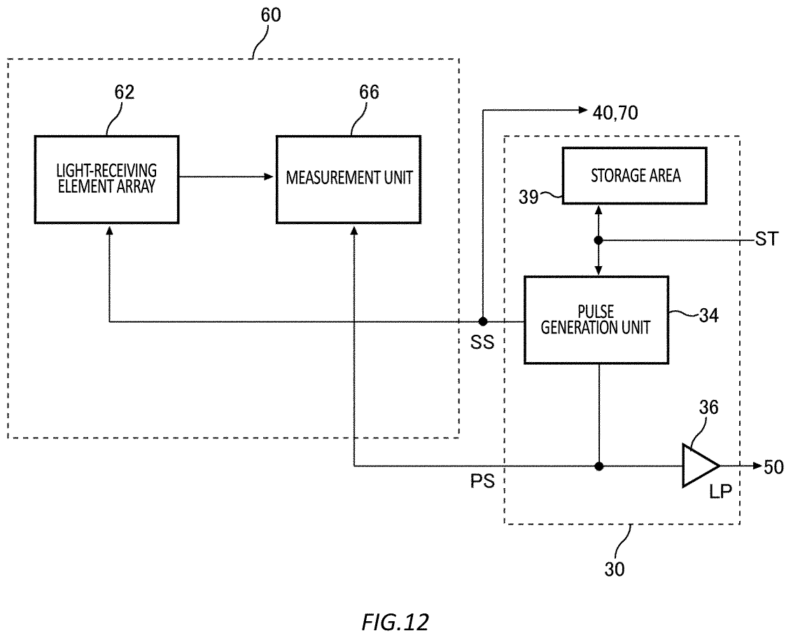

The storage area 39 is constituted by a storage element such as a memory (RAM, ROM), a register, a flip-flop, or the like. As shown in FIG. 6 and FIG. 12 described below, the storage area 39 is provided as a part of the pulse generation circuit 30 and the channel control circuit 40, or in the memory shared by the pulse generation circuit 30 and the channel control circuit 40. The storage area 39 stores the mode determination information and the state signals (the scan start signal SS in the present example) of the light-receiving unit 60 and the control unit 10. The mode determination information may be included in the scan start signal SS.

Mode determination information means information for determining whether the generation of the scan start signal SS is performed at the light-receiving unit 60 or the control unit 10. For example, a certain bit of the mode determination information is assigned in advance as being used for the determination of communication, and, when the mode determination bit is “0”, the light-receiving unit 60 generates the scan start signal SS and inputs it to the control unit 10. Otherwise, when the mode determination bit is “1”, the control unit 10 generates the scan start signal SS and inputs it to the light-receiving unit 60. It is noted that the logic value of the mode determination bit may be reversed. The mode determination process using the mode determination bit determines in which of the modes described above the ranging device 100 is operated. The mode determination information may be preset in the storage area 39 by a user or the like. In the ranging device 100 in the present example, “0” is set as the mode determination bit and the scan start signal SS is generated at the light-receiving unit 60. When the mode determination bit is “0”, the control unit 10 may notify the light-receiving unit 60 of the fact. The light-receiving unit 60 may generate the scan start signal SS in response to the operation instruction signal ST on condition that the mode determination bit is “0”.

The control unit 10 in the present example generates the channel select signal CH based on the scan start signal SS (a state signal) in the channel control circuit 40. In addition, the pulse generation circuit 30 generates the pulse signal LP in response to the light emission instruction signal LC synchronized with the scan start signal SS. Thus, the channel select signal CH and the pulse signal LP can be precisely synchronized.

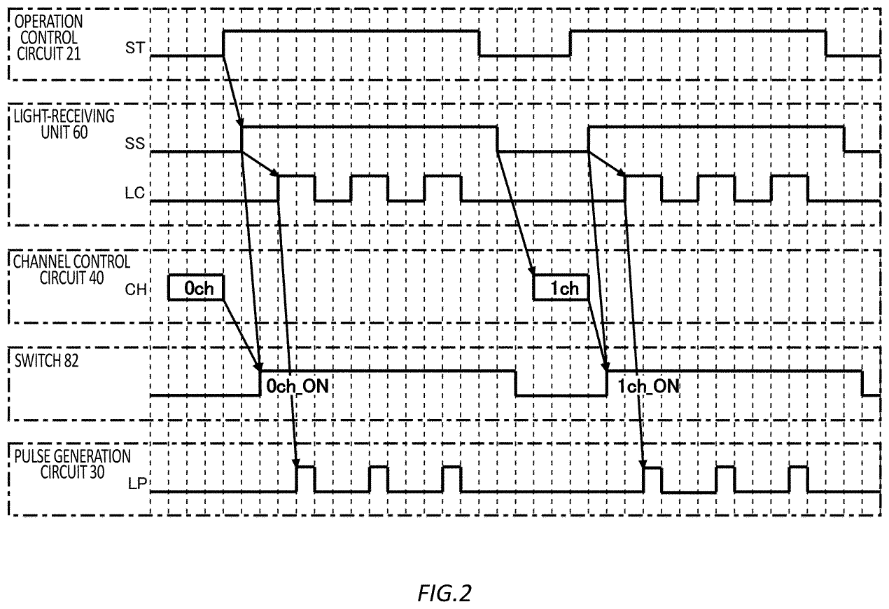

FIG. 2 is a timing chart showing a waveform example of each signal. The MCU unit 20 in the present example generates the operation instruction signal ST. The operation instruction signal ST in the present example is a signal which repeatedly determines a period when the light-receiving unit 60 can receive light (for example, a period of H logic value) and a period when it cannot receive light (for example, a period of logic value L).

The light-receiving unit 60 transitions between a state where it can receive light and a state where it cannot receive light in response to the operation instruction signal ST. The light-receiving unit 60 in the present example is in a state where it can receive light during a period when the operation instruction signal ST exhibits H logic, and is in a state where it cannot receive light during a period when the operation instruction signal ST exhibits L logic. The light-receiving unit 60 outputs the scan start signal SS indicating whether it is in a state where it can receive light. The scan start signal SS in the present example exhibits H logic when the light-receiving unit 60 is in a state where it can receive light, or exhibits L logic when it is in a state where it cannot receive light. The scan start signal SS in the present example corresponds to a signal which is delayed from the operation instruction signal ST by a predetermined delay amount. In the present specification, the period when the light-receiving unit 60 is in a state where it can receive light may be referred to as a scan period. For example, a single scan period refers to a period from when the scan start signal SS transitions to H logic until it transitions to L logic. As described above, the scan start signal SS is stored in the storage area 39 of the control unit 10.

When the light-receiving unit 60 in the present example transitions to the state where it can receive light, it generates the light emission instruction signal LC for causing the light-emitting element 72 to emit light. The light-receiving unit 60 may generate the light emission instruction signal LC such that the light-emitting element 72 emits light when a predetermined time elapses after the light-receiving unit 60 transitions to the state where it can receive light. The light emission instruction signal LC in the present example has a pulse delayed by a predetermined time from when the scan start signal SS transitions to H logic. The light-emitting element 72 emits light in response to the pulse. The light emission instruction signal LC may have a plurality of pulses during a period when the scan start signal SS is maintained at H logic. In this case, any of the light-emitting elements 72 emits light multiple times during a single scan period. The light-receiving unit 60 may measure the intensity of the reflected light for each light emission or may measure the total sum of the intensities of the reflected light from multiple times of light emissions.

The channel control circuit 40 outputs the channel select signal CH in response to the scan start signal SS. The channel control circuit 40 in the present example stops outputting the channel select signal to the light-emitting unit 70 in response to the state signal (the scan start signal SS) stored in the storage area 39 is H logic (that is, the information indicating that the light-receiving unit 60 is in a state where it can measure light from the target, or the information for enabling the light-receiving unit 60 to measure the light). Each time the scan start signal SS transitions to L logic, the channel control circuit 40 in the present example outputs the channel select signal CH which sequentially specifies each channel of the light-emitting unit 70. The channel control circuit 40 may output the channel select signal CH delayed by a predetermined time from an edge of the scan start signal SS. When the scan start signal SS transitions to H logic, the channel control circuit 40 stops outputting the channel select signal CH. In this way, the update of the channel select signal CH input to the switch 82 stops, preventing the channel switching while the light-emitting unit 70 is being driven.

The channel control circuit 40 in the present example outputs a digital signal indicating the number of a channel as a binary number or the like. In this case, the switch device 80 may have a decoder which converts the digital signal of the channel select signal CH into a control signal for each switch 82. For example, the switch device 80 may have a plurality of control lines for transmitting a control signal for each switch 82. In response to the channel select signal CH, the decoder may generate each control signal which turns on any of the switches 82 and turns off the other switches 82, and transmit it to each control line. The switch device 80 may have a register or the like which stores the channel number specified by the channel select signal CH. Since the switch device 80 is provided with the decoder, the control line to each switch 82 can be shorter, and the variation in the transmission delay time of the control signal to the switch 82 can be suppressed. Thus, the ranging device 100 can operate at a higher speed.

In response to the scan start signal SS and the channel select signal CH, the switch device 80 turns on any of the switches 82 and turns off the other switches 82. The switch device 80 in the present example controls the switch 82 corresponding to the channel specified by the channel select signal CH to switch to the ON state and controls the other switches 82 to switch to the OFF state at the timing when the input scan start signal SS transitions to H logic. As described above, the switch device 80 may read the channel number stored in the register or the like at the timing when the input scan start signal SS transitions to H logic. As described above, when any of the switches 82 is controlled to switch to the ON state, the corresponding light-emitting element 72 switches to the state where it can emit light. In the example of FIG. 1, the corresponding charge capacitor 74 is charged.

The pulse generation circuit 30 generates the light emission pulse signal LP in response to the light emission instruction signal LC. The light emission instruction signal LC is generated synchronously with the scan start signal SS. Thus, the light emission pulse signal LP may be generated synchronously with the scan start signal SS. The pulse generation circuit 30 may generate the light emission pulse signal LP on condition that the scan start signal SS of H logic is stored in the storage area 39. The light emission pulse signal LP in the present example has a pulse in accordance with the timing when the light emission instruction signal LC transitions to H logic. The light emission pulse signal LP in the present example has a pulse delayed by a predetermined time from each pulse of the light emission instruction signal LC. Each pulse of the light emission pulse signal LP is generated within a scan period. As shown in FIG. 2, the light emission pulse signal LP may have a plurality of pulses during a single scan period. The light emission pulse signal LP may have one or more pulses during a period when any of the switches 82 is controlled to switch to the ON state corresponding to a single scan period.

As described in FIG. 1, the driver 50 is controlled to switch to the ON state during a period when the light emission pulse signal LP exhibits H logic. When the driver 50 is controlled to switch to the ON state, the light-emitting element 72 in a state where it can emit light (that is, the light-emitting element 72 whose corresponding switch 82 is in the ON state) emits light.

As described above, the ranging device 100 in the present example outputs, to the control unit 10, the scan start signal SS indicating whether or not the light-receiving unit 60 is in a state where it can measure light from the target. The control unit 10 stores the scan start signal SS in the storage area 39. The control unit 10 may update the scan start signal SS stored in the storage area 39 in response to the received scan start signal SS. In this case, the ranging device 100 may operate in accordance with the logic value of the scan signal SS stored in the storage area 39. Alternatively, the control unit 10 may store the past history of the received scan start signal SS. In this case, the ranging device 100 may operate in accordance with the logic value of the latest scan start signal SS stored in the storage area 39.

In response to the scan start signal SS stored in the storage area 39 indicating that the light-receiving unit 60 can receive light, the control unit 10 outputs, to the light-emitting unit 70, the channel select signal CH for selecting which of the plurality of light-emitting elements 72 is to emit light and the light emission control signal (the light emission pulse signal LP in the present example). In other words, the light-emitting unit 70 in the present example is driven in response to the scan start signal SS output from the light-receiving unit 60 is the information indicating that the light-receiving unit 60 being in a state where it can measure reflected light from the target. In addition, in the present example, both the timing when the channel select signal CH is generated and the timing when the light emission pulse signal LP is generated are based on the scan start signal SS. Thus, the impact of the variation in the operation time between the MCU unit 20 and the light-receiving unit 60 can be suppressed, which can precisely synchronize the channel select signal CH and the light emission pulse signal LP.

In response to the state signal stored in the storage area 39 being different from both the information indicating that the light-receiving unit 60 is in the state where it can measure light from the target and the information for enabling the light-receiving unit 60 to measure the light (in the present example, the scan start signal SS being L logic), the channel control circuit 40 outputs a new channel select signal CH to the light-emitting unit 70 and the pulse generation circuit 30 stops outputting the light emission control signal (the light emission pulse signal LP) to the light-emitting unit 70. In this way, the light emission process in the channel ends and the channel select signal CH for specifying the next channel is generated. Then, the scan start signal SS transitions to H logic again so that the process for causing the next channel to emit light is performed.

To cause the light-emitting element 72 to emit light, the light emission pulse signal LC must be generated during a period when the corresponding switch 82 is in the ON state. Therefore, when the variation in the delay time is great between the channel select signal CH and the light emission pulse signal LP, a margin must be provided such that, for example, the period when the switch 82 is controlled to be in the ON state is long enough to include the period of the light emission pulse signal LC. Since the channel select signal CH and the light emission pulse signal LP can be precisely synchronized in the present example, the margin can be reduced, a single scan period can be made short, and the ranging device 100 can be caused to operate at high speed.

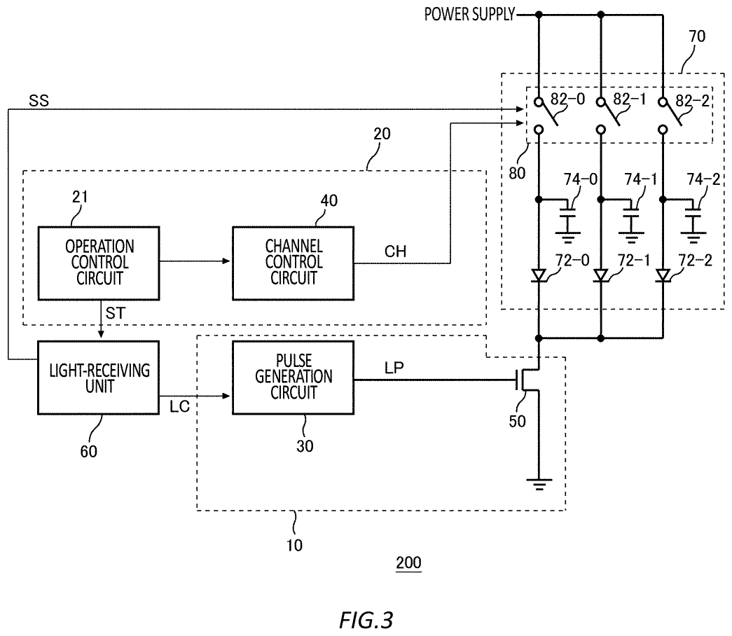

FIG. 3 is a diagram showing one example of the ranging device 200 according to a comparative example. The components in FIG. 3 with the same reference numerals as those in FIG. 1 have similar functions to those in the example of FIG. 1 unless otherwise described. The ranging device 200 has a control unit 10, an MCU unit 20, a light-receiving unit 60, and a light-emitting unit 70. The configuration of the light-emitting unit 70 may be similar to that of the example of FIG. 1. However, the MCU unit 20 in the present example incorporates the operation control circuit 21 and the channel control circuit 40, and the light-emitting unit 70 in the present example has no decoder. The ranging device 200 is different from the ranging device 100 in the method for generating the channel select signal CH and the light emission pulse signal LP.

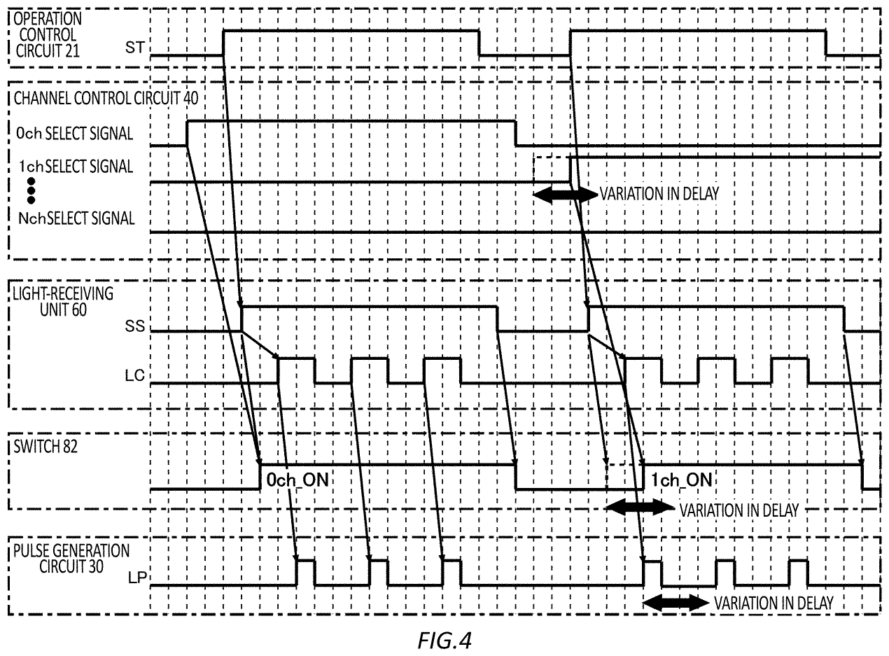

FIG. 4 is a timing chart showing a waveform example of each signal in the ranging device 200. The operation control circuit 21 in the present example generates the operation instruction signal ST. The channel control circuit 40 generates the channel select signal CH in response to the operation instruction signal ST. The channel control circuit 40 in the present example generates the channel select signal CH for each channel of the light-emitting unit 70 and inputs it to the switch device 80.

The channel control circuit 40 in the example of FIG. 4 generates 0ch select signal to Nch select signal corresponding to the zeroth channel to the Nth channel. In the period when each select signal is at H logic, the corresponding switch 82 is controlled to be in the ON state. Each time the operation control signal ST transitions to L logic, the channel control circuit 40 may cause the select signal corresponding to the next channel to transition to H logic.

The light-receiving unit 60 generates the scan start signal SS in response to the operation instruction signal ST. The light-receiving unit 60 inputs the scan start signal SS to the switch device 80. In addition, the light-receiving unit 60 generates the light emission instruction signal LC in response to the scan start signal SS.

The switch device 80 controls any of the switches 82 to switch to the ON state and controls the other switches 82 to switch to the OFF state in response to the scan start signal SS and the channel select signal CH. The pulse generation circuit 30 generates the light emission pulse signal LP in response to the light emission instruction signal LC and inputs it to the driver 50.

In the ranging device 200, both the timing when the channel select signal CH is generated and the timing when the light emission pulse signal LP is generated are based on the operation instruction signal ST. Then, the channel select signal CH is transmitted from the operation control circuit 21 to the switch device 80 via the channel control circuit 40. The channel select signal CH changes in its phase depending on the variation in the delay time of the transmission path. In addition, the light emission pulse signal LP input to the driver 50 is transmitted from the operation control circuit 21 to the driver 50 via the light-receiving unit 60 and the pulse generation circuit 30. The light emission pulse signal LP changes in its phase depending on the variation in the delay time of the transmission path. Therefore, it is difficult to precisely synchronize the channel select signal CH and the light emission pulse signal LP in the ranging device 200.

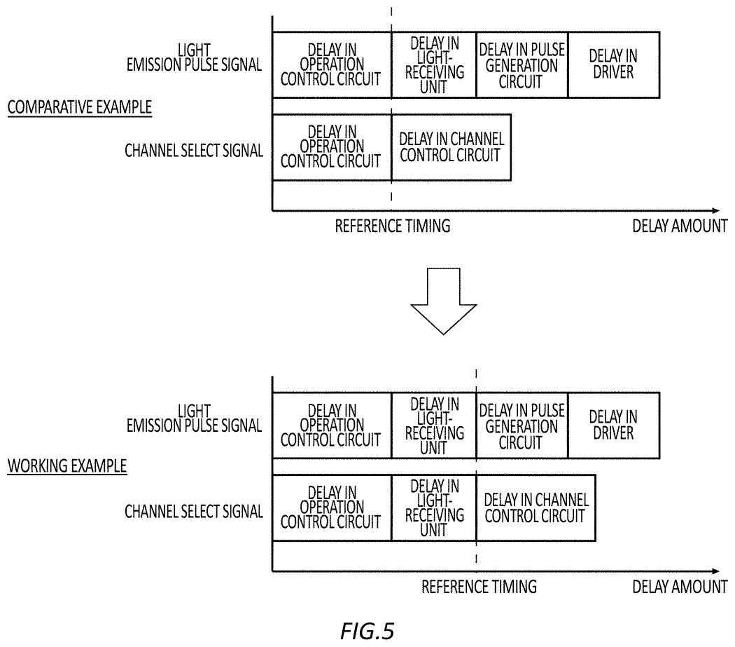

FIG. 5 is a diagram showing a cause of variation in the delay time of a light emission pulse signal LP and a channel select signal CH in the ranging device 200 according to the comparative example and in the ranging device 100 according to a working example. In the ranging device 200 in the comparative example, the light emission pulse signal LP is affected by a delay at each component because it passes through the MCU unit 20 (the operation control circuit 21), the light-receiving unit 60, the pulse generation circuit 30, and the driver 50. On the other hand, the channel select signal CH is affected by the delay at each component because it passes through the operation control circuit 21 and the channel control circuit 40. In this manner, the light emission pulse signal LP and the channel select signal CH in the ranging device 200 pass through separate circuits downstream of the operation control circuit 21. Thus, the variation in the delay time tends to be great.

In the ranging device 100 in the working example, the light emission pulse signal LP passes through the MCU unit 20 (the operation control circuit 21), the light-receiving unit 60, the pulse generation circuit 30, and the driver 50. On the other hand, the channel select signal CH passes through the MCU unit 20 (the operation control circuit 21), the light-receiving unit 60, and the channel control circuit 40. That is, since the light emission pulse signal LP and the channel select signal CH pass through the same path up to the light-receiving unit 60, the variation in the delay time can be suppressed.

FIG. 6 is a diagram showing a configuration example of the light-receiving unit 60 and the pulse generation circuit 30. The light-receiving unit 60 in the present example has a light-receiving element array 62, a state control circuit 64, a measurement unit 66, and a first timing control unit 68. The light-receiving element array 62 has a plurality of light-receiving elements arranged two-dimensionally on a plane or a curved surface. The light-receiving element is, for example, a photoelectric conversion element such as a photodiode, but is not limited thereto. The pulse generation circuit 30 in the present example has a pulse generation unit 34 and a preamplifier 36, and is configured to be able to access the storage area 39 incorporated in the control unit 10. The storage area 39 may be provided in the pulse generation circuit 30 or may be provided in the control unit 10 other than the pulse generation circuit 30.

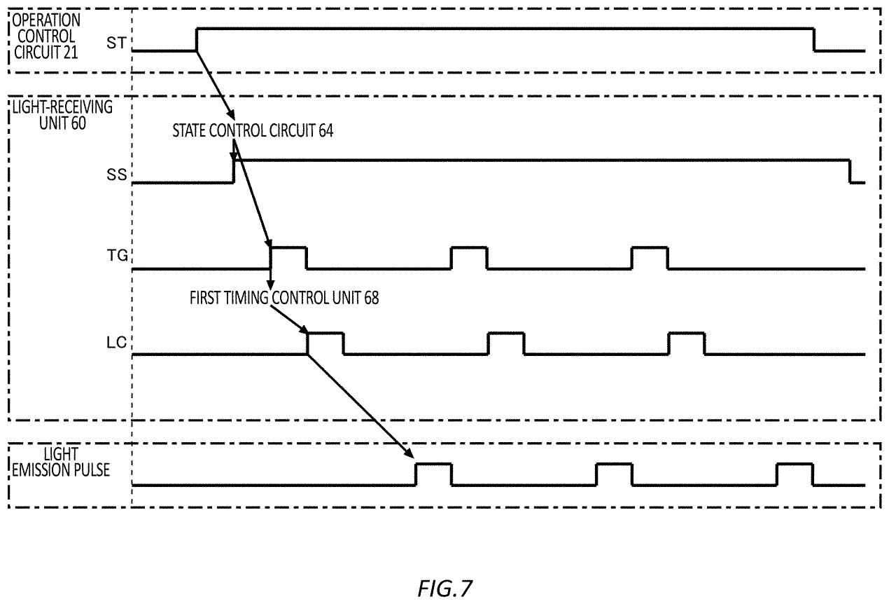

FIG. 7 is a timing chart describing an operation example of the light-receiving unit 60 and the pulse generation circuit 30 shown in FIG. 6. In the present example, the light-receiving unit 60 generates the scan start signal SS based on the mode determination bit stored in the storage area 39. The light-receiving unit 60 inputs the scan start signal SS to the control unit 10, and this scan start signal SS is stored in the storage area 39 as a state signal. The pulse generation unit 34 can accept the light emission instruction signal LC only during the period when the state signal is in H logic, that is, the period when it can receive light. The pulse generation unit 34 outputs the light emission pulse signal LP in response to the light emission instruction signal LC accepted during the period when it can receive light.

The operations of the light-receiving unit 60 and the pulse generation circuit 30 will now be described in more detail. In response to the operation instruction signal ST, the state control circuit 64 inputs, to the light-receiving element array 62, the scan start signal SS for controlling the light-receiving element array 62. The scan start signal SS is a signal for setting the light-receiving element array 62 to a state where it can measure reflected light from the target. For example, the scan start signal SS is a signal which enables a photoelectric conversion operation in the photoelectric conversion element. The scan start signal SS may be a signal for switching the connection of the photoelectric conversion element to the power supply. The state control circuit 64 inputs the scan start signal SS to the channel control circuit 40 and the light-emitting unit 70 by storing it in the storage area 39 of the control unit 10 as the state signal indicating the state of the light-receiving unit 60.

The state control circuit 64 inputs the trigger signal TG to the first timing control unit 68 in response to the operation instruction signal ST. The trigger signal TG is a signal which determines the timing to cause the light-emitting element 72 to emit light. The state control circuit 64 outputs the trigger signal TG synchronously with the scan start signal SS. The number of pulses of the trigger signal TG depends on the number of times the light-emitting element 72 is caused to emit light during a single scan period. The first pulse of the trigger signal TG may be delayed by a set delay amount relative to the timing when the scan start signal SS transitions to H logic.

The first timing control unit 68 outputs the light emission instruction signal LC in response to the trigger signal TG. The light emission instruction signal LC may be a signal delayed with respect to the trigger signal TG.

The measurement unit 66 measures the distance to the target based on the result of receiving the reflected light at the light-receiving element array 62 and the light emission instruction signal LC. The measurement unit 66 may calculate the distance to the target based on the time from when the light emission instruction signal LC instructs light emission until the light-receiving element array 62 receives the reflected light.

The pulse generation unit 34 generates the light emission pulse signal LP with a preset pulse width in response to the light emission instruction signal LC. The preamplifier 36 adjusts the amplitude of the light emission pulse signal LP to a preset level and inputs it to the driver 50. When the driver 50 switches to the ON state in response to the light emission pulse signal LP, the light-emitting element 72 emits light.

In the present example, the scan start signal SS with which the state control circuit 64 controls the light-receiving element array 62 is used as the state signal of the light-receiving unit 60. The channel control circuit 40 generates the channel select signal CH synchronously with the scan start signal SS. In addition, the trigger signal TG is generated by the state control circuit 64 synchronously with the scan start signal SS. Thus, for example, even if the operation timing in the state control circuit 64 has variation, causing variation in the phase of the scan start signal SS, the impact on the relative phase between the channel select signal CH and the light emission pulse signal LP can be suppressed.

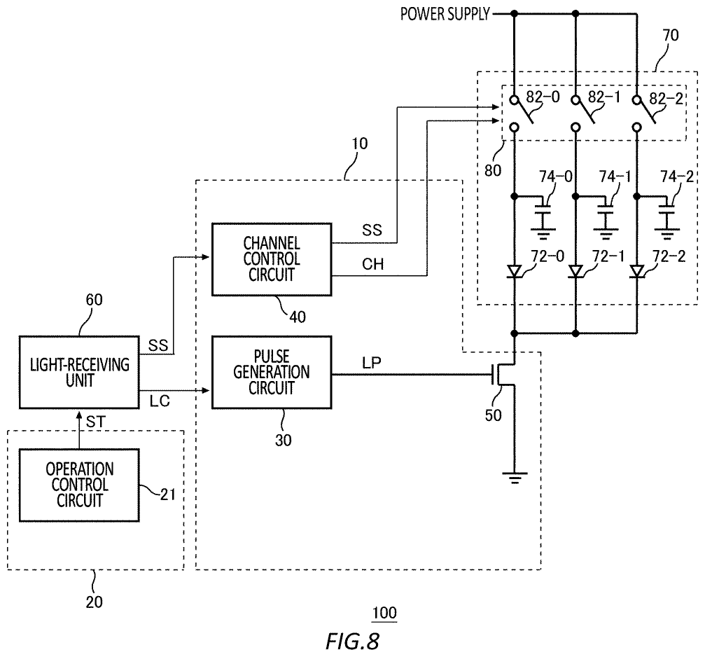

FIG. 8 is a diagram showing another configuration example of the ranging device 100. The ranging device 100 in the present example is different from the other examples in the operation of the channel control circuit 40. Other than the operation of the channel control circuit 40, it is similar to any of the ranging devices 100 described in the present specification.

As in the example of FIG. 1, the channel control circuit 40 in the present example outputs the channel select signal CH. In addition, the channel control circuit 40 synchronously inputs the scan start signal SS and the channel select signal CH to the light-emitting unit 70.

Since the channel control circuit 40 outputs the scan start signal SS and the channel select signal CH in a synchronized state, the scan start signal SS and the channel select signal CH can be precisely synchronized. That is, both the scan start signal SS and the channel select signal CH are input to the switch device 80 via the channel control circuit 40, the impact of the variation in delay at the channel control circuit 40 can be suppressed, which can precisely synchronize the scan start signal SS and the channel select signal CH.

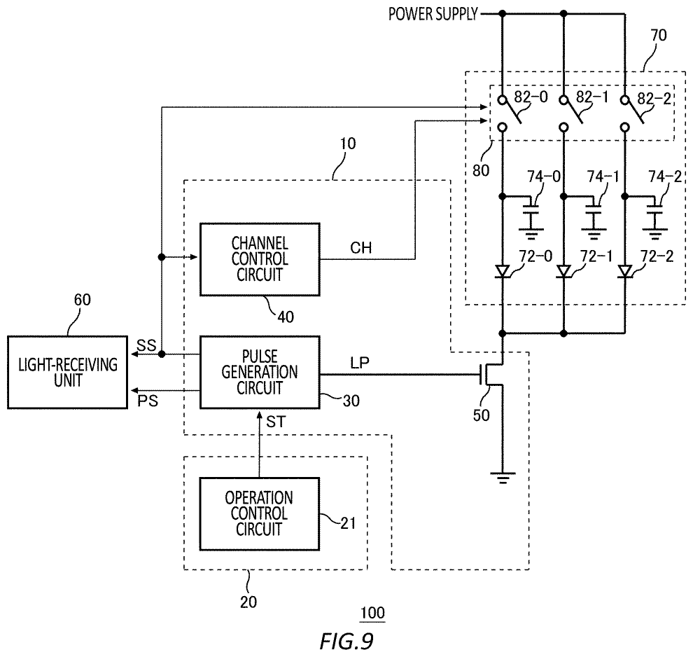

FIG. 9 is a diagram showing another configuration example of the ranging device 100. The MCU unit 20, the pulse generation circuit 30, and the light-receiving unit 60 in the ranging device 100 in the present example are different from those of other examples. Other than the MCU unit 20, the pulse generation circuit 30, and the light-receiving unit 60, it is similar to any of the ranging devices 100 described in the present specification.

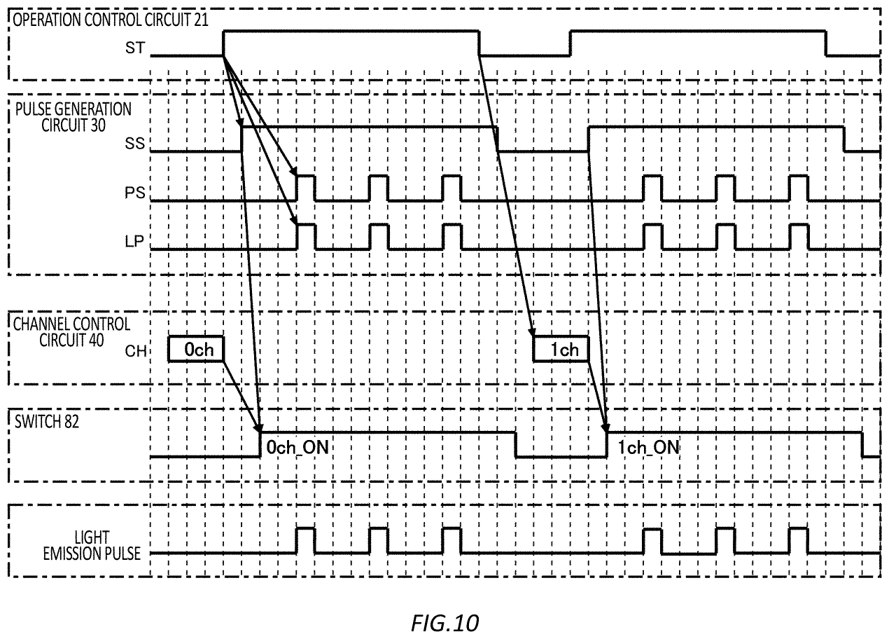

FIG. 10 is a timing chart showing a waveform example of each signal in the example shown in FIG. 9. In the present example, based on the mode determination bit stored in the storage area 39, the control unit 10, more specifically, the pulse generation circuit 30, generates the scan start signal SS and stores it in the storage area 39 as the state signal. The pulse generation circuit 30 can output the light emission pulse signal LP and outputs the pulse start signal PS only during the period when the state signal is in H logic. This will now be described in more detail. The control unit 10 in the present example generates the state signal for controlling the light-receiving unit 60 to switch to the state where it can measure light from the target, and inputs it to the light-receiving unit 60. In the example of FIG. 9, the MCU unit 20 inputs the operation instruction signal ST to the pulse generation circuit 30. The pulse generation circuit 30 generates the scan start signal SS in response to the operation instruction signal ST. The scan start signal SS is one example of the state signal. The pulse generation circuit 30 inputs the scan start signal SS to the light-receiving unit 60, the channel control circuit 40, and the switch device 80. The waveform of the scan start signal SS is similar to that of the other examples of the ranging device 100.

The pulse generation circuit 30 generates the light emission pulse signal LP synchronized with the scan start signal SS. The waveform of the light emission pulse signal LP is similar to that of the other examples of the ranging device 100.

The pulse generation circuit 30 may input the pulse start signal PS to the light-receiving unit 60 in addition to the scan start signal SS. The pulse start signal PS may be a signal similar to the light emission pulse signal LP. That is, the pulse start signal PS is a signal indicating the timing to cause the light-emitting element 72 to emit light. Based on the pulse start signal PS, the measurement unit 66 in the light-receiving unit 60 may measure the time from when the light-emitting element 72 emits light until the light-receiving unit 60 receives the reflected light. That is, the ranging device 100 in the present example includes the information for the scan start signal SS to enable the light-receiving unit 60 to perform measurement. The control unit 10 generates the scan start signal SS in response to the operation instruction signal ST and stores it in the storage area 39. In response to this scan start signal SS being stored, the control unit 10 outputs, to the light-emitting unit 70, the channel select signal CH and the light emission control signal (the light emission pulse signal LP in the present example) for selecting which of the plurality of light-emitting elements 72 is to emit light. In other words, the light-emitting unit 70 in the present example is driven in response to the scan start signal SS output from the light-receiving unit 60 being the information for enabling the light-receiving unit 60 to perform measurement.

The operations of the channel control circuit 40, the driver 50, and the light-emitting unit 70 are similar to those in the example of FIG. 2. For example, the channel control circuit 40 generates the channel select signal CH based on the scan start signal SS, which is one example of the state signal. According to the example of FIG. 9, the light-receiving unit 60 is excluded from the transmission path of the light emission pulse signal LP and the channel select signal CH. This can eliminate the impact of the variation in delay inside the light-receiving unit 60 or the like, and more precisely synchronize the light emission pulse signal LP and the channel select signal CH.

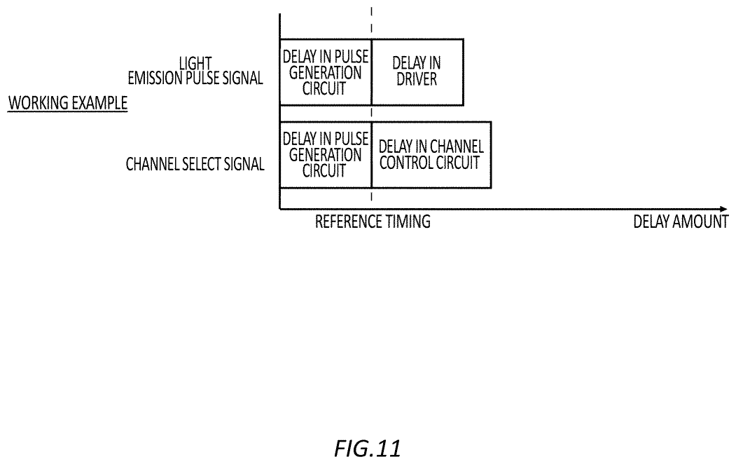

FIG. 11 is a diagram showing a cause of variation in the delay time of the light emission pulse signal LP and the channel select signal CH in the ranging device 100 according to the example of FIG. 9. In the ranging device 100 in the present example, the light emission pulse signal LP passes through the pulse generation circuit 30 and the driver 50. On the other hand, the channel select signal CH passes through the pulse generation circuit 30 and the channel control circuit 40. That is, since both the light emission pulse signal LP and the channel select signal CH pass through the same path until the pulse generation circuit 30, the variation in the delay time can be suppressed.

FIG. 12 is a diagram showing a configuration example of the light-receiving unit 60 and the pulse generation circuit 30 in the example of FIG. 9. The light-receiving unit 60 in the present example has the light-receiving element array 62 and the measurement unit 66. The light-receiving element array 62 in the present example is similar to that of the other examples in the present specification, except that it operates in response to the scan start signal SS from the pulse generation circuit 30. The measurement unit 66 in the present example measures the time from the timing of the light emission pulse indicated by the pulse start signal PS from the pulse generation circuit 30 to the timing when the light-receiving element array 62 receives the reflected light.

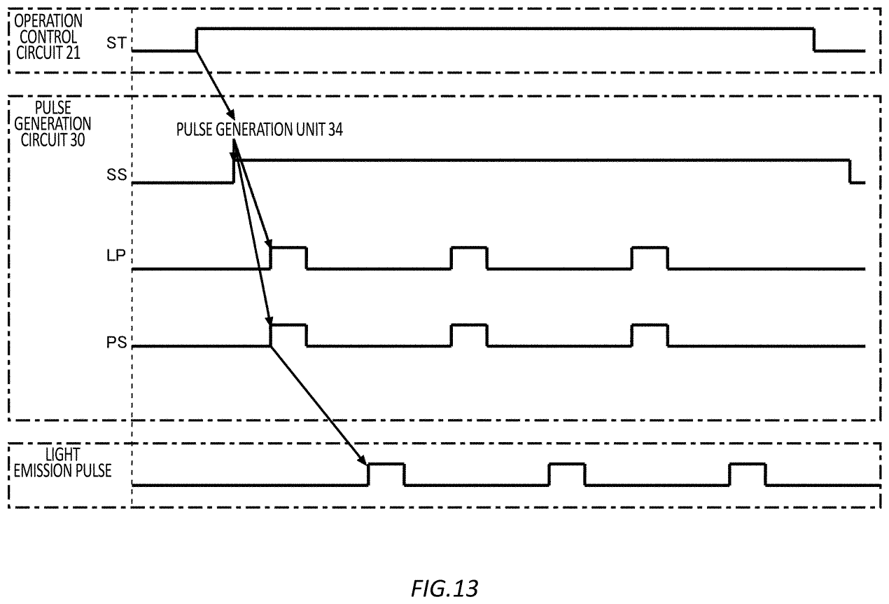

FIG. 13 is a timing chart showing a waveform example of each signal in the example shown in FIG. 12. The configuration of the pulse generation circuit 30 in the example of FIG. 12 is similar to that of the example of FIG. 6. However, the pulse generation unit 34 in the present example generates the scan start signal SS in response to the operation instruction signal ST and inputs it to the light-receiving element array 62, the channel control circuit 40, and the light-emitting unit 70.

The pulse generation unit 34 generates the light emission pulse signal LP and the light emission start signal PS in response to the operation instruction signal ST. The light emission pulse signal LP and the light emission start signal PS may be the same signal. The pulse generation unit 34 inputs the light emission pulse signal LP to the driver 50 via the preamplifier 36. In this way, the light-emitting element 72 emits light. In addition, the pulse generation unit 34 inputs the light emission start signal PS to the measurement unit 66. In this way, the measurement unit 66 can sense the light emission timing of the light-emitting element 72.

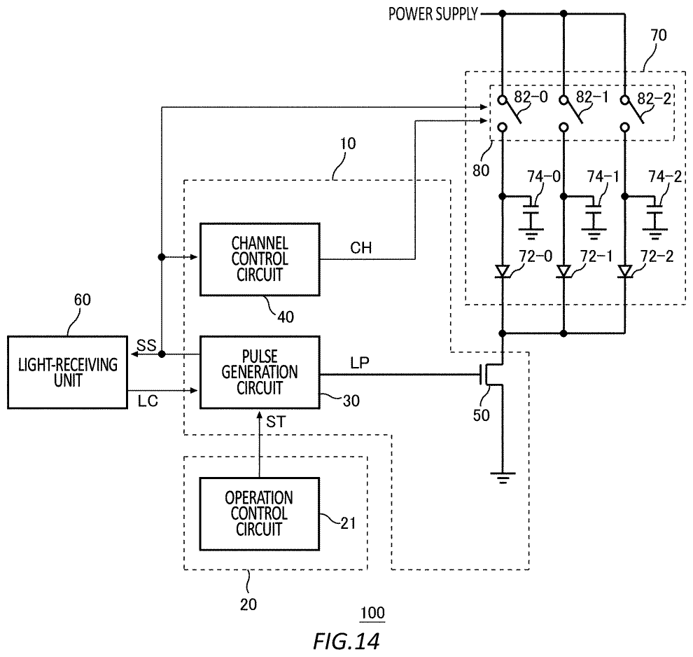

FIG. 14 is a diagram showing another configuration example of the ranging device 100. The present example is different from the example of FIG. 9 in that the light-receiving unit 60 outputs the light emission instruction signal LC in response to the scan start signal SS. Other structures are similar to those in the example of FIG. 9.

In the light-receiving unit 60 in the present example, the light-receiving element array 62 is controlled in response to the scan start signal SS. When the light-receiving element array 62 switches to the state where it can receive light in response to the scan start signal SS, it may output the light emission instruction signal LC. According to the present example, the channel select signal CH and the light emission pulse signal LP can also be generated based on the scan start signal SS.

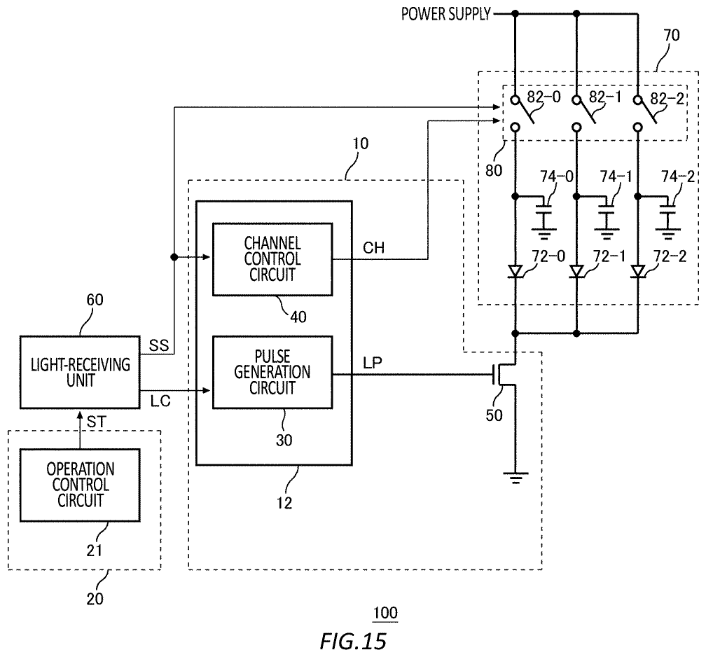

FIG. 15 is a diagram showing another configuration example of the control unit 10. The control unit 10 in the present example is different from the other examples described in the present specification in that it includes a control chip 12. The structures other than the control chip 12 are similar to those of any of the examples described in the present specification. In FIG. 15, the control chip 12 is applied to the structure shown in FIG. 1, but the control chip 12 may be applied to a structure of another example.

The control chip 12 has a channel control circuit 40 and a pulse generation circuit 30. That is, the channel control circuit 40 and the pulse generation circuit 30 in the present example are formed on the same control chip 12. Being formed on the same control chip 12 may refer to being formed on the same semiconductor substrate. Alternatively, it may refer to being integrated on the same semiconductor substrate. The control chip 12 may further be provided with another component of the control unit 10. For example, the control chip 12 may further be provided with the driver 50.

Each circuit formed inside the control chip 12 may operate in response to the common clock signal. Thus, the variation in the operation time between the channel control circuit 40 and the pulse generation circuit 30 can be further reduced. Thus, the light emission pulse signal LP and the channel select signal CH can be more precisely synchronized. In addition, a common power supply voltage may be applied to each circuit formed inside the control chip 12. Thus, even if there is variation in the power supply voltage, the power supply voltage of each circuit varies similarly, which causes the operation timing of each circuit to vary similarly.

In each example described in the present specification, the channel control circuit 40 and the pulse generation circuit 30 may operate synchronously. As in the present example, the channel control circuit 40 and the pulse generation circuit 30 are provided in a single chip so that the operations of the two circuits can be easily synchronized. The control unit 10 may generate the light emission pulse signal LP synchronously with the channel select signal CH. For example, the light emission pulse signal LP and the channel select signal CH may be output synchronously with a common clock signal.

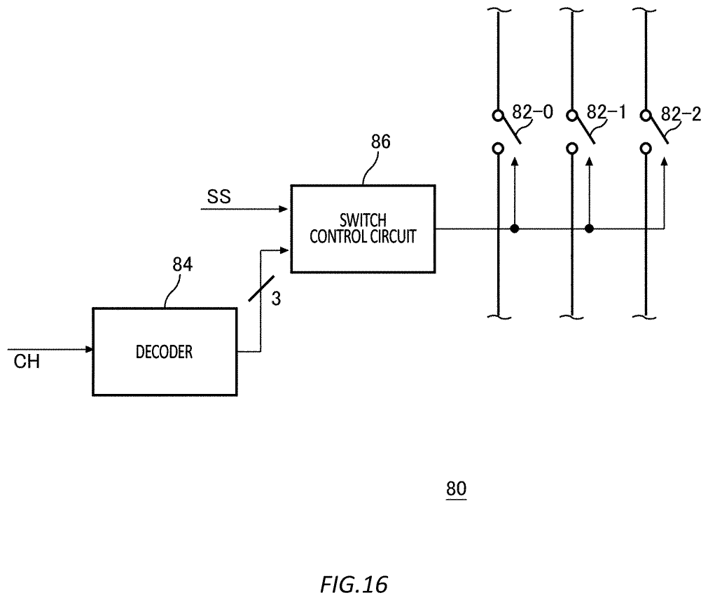

FIG. 16 is a diagram showing a configuration example of the switch device 80. The switch device 80 in the present example has a plurality of switches 82, a decoder 84, and a switch control circuit 86. The channel select signal CH is input to the decoder 84. The channel select signal CH in the present example is a digital signal indicating the number of the channels as a binary number or the like. The decoder 84 outputs the control signal having the bits corresponding to each switch 82 based on the channel select signal CH. In the example of FIG. 16, the switch device 80 has three switches 82, and the control signal is three-bit. For example, the control signal is a signal where the bit corresponding to the switch 82 specified by the channel select signal CH is one, and the other bits are zero.

The switch control circuit 86 controls each switch 82 based on the scan start signal SS and the control signal from the decoder 84. For example, the switch control circuit 86 reads out which of the switches 82 is specified by the control signal from the decoder 84 at the timing when the scan start signal SS transitions to L logic, and sets the switch 82 to the ON state and sets the other switches 82 to the OFF state at the timing when the scan start signal SS transitions to H logic.

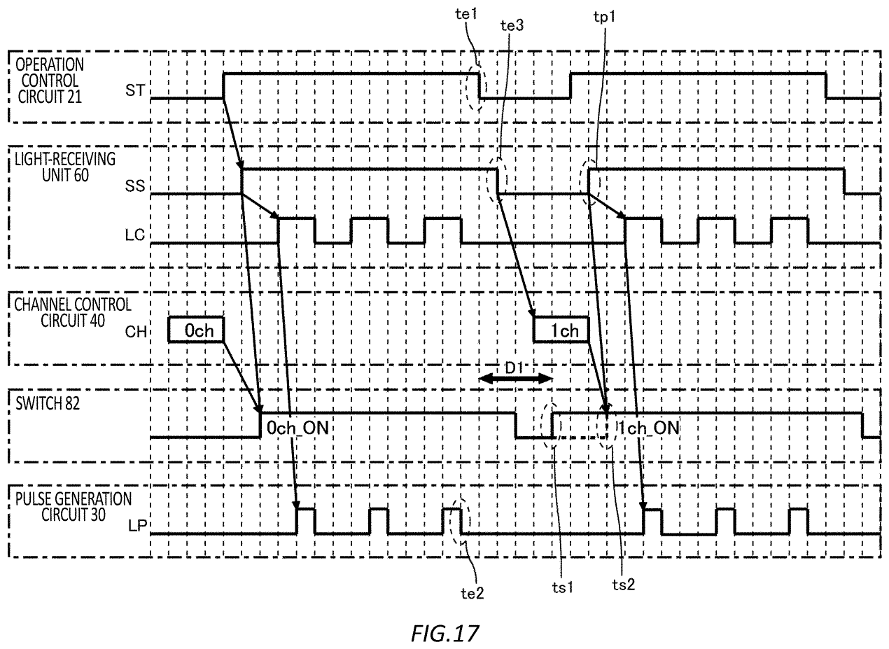

FIG. 17 is a timing chart describing another operation example of the switch device 80. The operations of the MCU unit 20 (the operation control circuit 21), the light-receiving unit 60, and the channel control circuit 40 are similar to those of the example of FIG. 2. As described in FIG. 1 or the like, the light-emitting element corresponding to the charged charge capacitor 74 among the plurality of light-emitting elements 72 emits light in response to the light emission pulse signal LP. As described above, the channel control circuit 40 sets the channel that is to emit light next (that is, the light-emitting element 72) at the timing when the scan start signal SS transitions to L logic.

The switch control circuit 86 in the present example detects the end timing when any of the light-emitting elements 72 emits light, controls the switch 82 corresponding to the light-emitting element 72 that is to emit light next to switch to the ON state based on the end timing, and precharges the corresponding charge capacitor 74. The switch control circuit 86 in the present example starts charging the charge capacitor 74 of the channel that is to emit light next in response to the timing when the channel currently emitting light ends emitting light, regardless of the timing when the scan start signal SS transitions to H logic. Such a control can reduce the time from the start of the next scan period until the start of the light emission of the light-emitting element 72. In this way, the ranging device 100 can operate at a higher speed.

As described above, the light-receiving unit 60 repeats the state where it can measure the light from the target and the state where it cannot measure the light. The state can be sensed through the state signal, such as the scan start signal SS. After detecting the end timing of the light emission of the light-emitting element 72, the switch control circuit 86 may control the switch 82 corresponding to the light-emitting element 72 that is to emit light next to switch to the ON state before the light-receiving unit 60 next switches to the state where it can measure the light.

The switch control circuit 86 may sense the end timing of the light emission of the light-emitting element 72 based on the state signal. In the example of FIG. 17, the switch control circuit 86 may sense, as the end timing, the timing te3 when the scan start signal SS transitions to L logic. The switch control circuit 86 may sense, as the end timing, the timing te1 when the operation instruction signal ST transitions to L logic. The switch control circuit 86 may detect the end timing based on the light emission control signal, such as the light emission pulse signal LP or the light emission instruction signal LC. For example, the switch control circuit 86 may sense, as the end timing, the timing te2 of the trailing edge of the last pulse in the scan period among each pulse of the light emission pulse signal LP.

When a preset time D1 elapses since the sensed end timing, the switch control circuit 86 may control the switch 82 of the channel that is to emit light next to switch to the ON state. The time D1 may be measured by a counter which counts clock pulses or the like. In the example of FIG. 17, the switch 82 of the first channel is controlled to switch to the ON state at the timing ts1. The time D1 may be shorter than the time from when the scan start signal SS transitions to L logic until it transitions to H logic. The timing ts1 is earlier than the timing ts2 when the switch 82 of the first channel is controlled to switch to the ON state in the example of FIG. 2 or the like. The timing ts1 may be earlier than the timing tp1 when the scan start signal SS transitions to H logic to start the next channel period. By such control, the timing when the light-emitting element 72 can start light emission can become earlier, and the ranging device 100 can operate at a higher speed. In addition, since the charge time of the charge capacitor 74 can be made longer, the charge amount of the charge capacitor 74 can be secured even if the ON resistance of the switch 82 is relatively high. Thus, the cost of the switch 82 can be reduced, or the scale of the circuit can be reduced by using the switch 82 which is smaller.

In the example of FIG. 17, the period 0ch_ON when the switch 82-0 is on and the period 1ch_ON when the switch 82-1 is on are separated. In another example, the end portion of the period 0ch_ON and the start portion of the period 1ch_ON may overlap. That is, there may be a period when the two switches 82 are turned on at the same time. However, even in this case, the period 1ch_ON starts after the light emission of the light-emitting element 72 of 0ch ends.

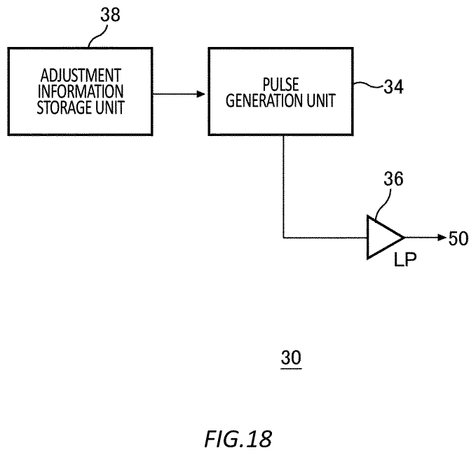

FIG. 18 is a diagram showing another configuration example of the pulse generation circuit 30. The pulse generation circuit 30 in the present example has an adjustment information storage unit 38. The structures other than the adjustment information storage unit 38 are similar to those of any example described in the present specification.

The adjustment information storage unit 38 stores the information for adjusting the pulse characteristics of the light emission pulse signal LP generated by the pulse generation unit 34. The adjustment information storage unit 38 may store the information for adjusting at least one of the phase (or the delay amount), a pulse width, or the pulse amplitude of each pulse of the light emission pulse signal LP.

For example, in the adjustment information storage unit 38, the delay amount relative to the light emission pulse signal LP may be set to adjust the variation in the transmission time of the signal transmission path from the light-receiving unit 60 to the driver 50. The transmission time of the transmission path may be measured when the ranging device 100 is shipped or during actual operation. In the adjustment information storage unit 38, the delay amount relative to the light emission pulse signal LP may be set such that the transmission time is within a predetermined allowable range. In addition, in the adjustment information storage unit 38, the delay amount relative to the light emission pulse signal LP may be set such that the difference between the timing when the channel select signal CH is input to the switch device 80 and the timing when the light emission pulse signal LP is input to the driver 50 is within a predetermined allowable range. The adjustment information storage unit 38 may store the information for adjusting the pulse width and the pulse amplitude of the light emission pulse signal LP such that the light emission intensity and the light emission time of the light-emitting element 72 are within a predetermined allowable range.

In the adjustment information storage unit 38, the adjustment information may be stored for each channel of the light-emitting unit 70. The adjustment information may be, for example, the information for adjusting the variation in at least one of the light emission delay time, light emission intensity, or light emission pulse width of the light-emitting element 72 for each channel. In this case, the channel select signal CH may be input to the pulse generation circuit 30. The pulse generation unit 34 may adjust the light emission pulse signal LP by using the adjustment information corresponding to the channel select signal CH. The adjustment information in this case may be set by the manufacturer, a user, or the like of the ranging device 100. Then, the difference between at least one of the ideal light emission delay time, light emission intensity, or light emission pulse width and the actual light emission characteristics for each channel of the light-emitting unit 70 obtained by actually measuring the light emission may be calculated to obtain the adjustment information, which may be stored in the adjustment information storage unit 38. Alternatively, for example, an adjustment mode may be provided. A set value may be given as the reference for at least one of the ideal light emission delay time, light emission intensity, or light emission pulse width. The difference between the data of the actual light emission characteristics, obtained by automatically turning on the channel, and the reference value may be automatically calculated and stored in the adjustment information storage unit 38 as the adjustment information.

The adjustment of the delay of the pulse or the pulse width of the light emission pulse signal LP can be achieved by, for example, a DLL circuit or the like. However, the means for adjusting the delay or pulse width are not limited to the DLL. In addition, when the pulse amplitude is adjusted, the power supply voltage supplied to the preamplifier 36 may be adjusted.

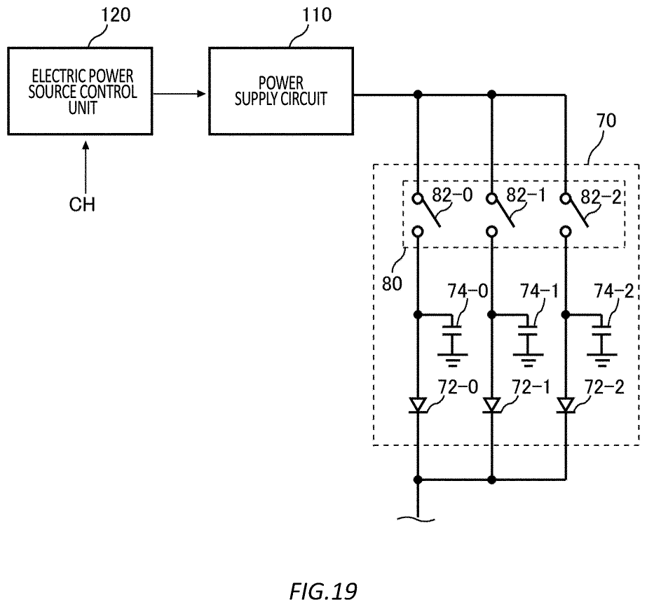

FIG. 19 is a diagram showing a configuration example where a power supply circuit 110 for supplying power supply voltage to the light-emitting unit 70 and the electric power source control unit 120 are provided. The power supply circuit 110 may have, for example, a DCDC converter. The electric power source control unit 120 adjusts the magnitude of the power supply voltage generated by the power supply circuit 110.

The channel select signal CH may be input to the electric power source control unit 120. The electric power source control unit 120 may adjust the power supply voltage of the power supply circuit 110 for each channel specified by the channel select signal CH. That is, the electric power source control unit 120 may change the power supply voltage of the power supply circuit 110 depending on which of the switches 82 is controlled to switch to the ON state by the switch device 80. The power supply voltage can be adjusted for each channel of the light-emitting unit 70 to suppress the variation in the light emission intensity or the like due to the variation in the characteristics of the light-emitting element 72, the charge capacitor 74, and the switch 82.

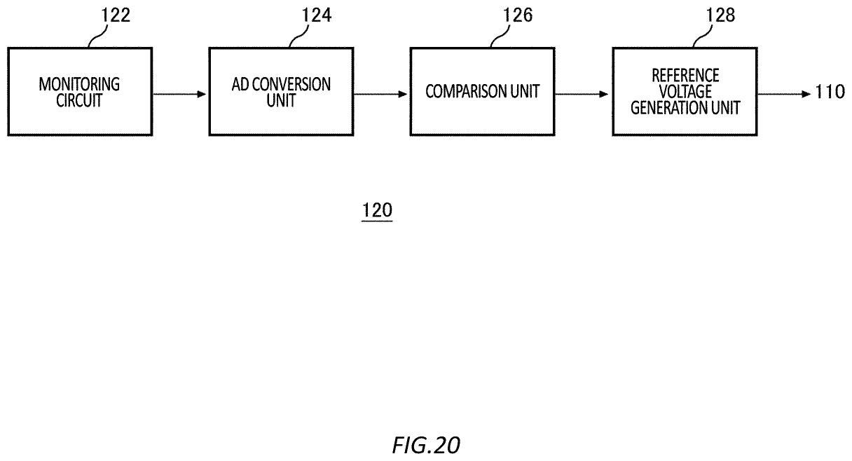

FIG. 20 is a diagram showing a configuration example of the electric power source control unit 120. The electric power source control unit 120 in the present example has a monitoring circuit 122, an AD conversion unit 124, a comparison unit 126, and a reference voltage generation unit 128. The monitoring circuit 122 senses an analog value in the light-emitting unit 70, such as the power supply voltage output by the power supply circuit 110, the amplitude and pulse width of the light emission pulse of the light-emitting element 72, the voltage of the charge capacitor 74, or the like.

The AD conversion unit 124 converts the analog value sensed by the monitoring circuit 122 into a digital value. The comparison unit 126 compares the digital value output by the AD conversion unit 124 to the preset set value. The reference voltage generation unit 128 adjusts the power supply voltage of the power supply circuit 110 based on the comparison result in the comparison unit 126. The reference voltage generation unit 128 adjusts the power supply voltage such that the digital value output by the AD conversion unit 124 approaches the set value.

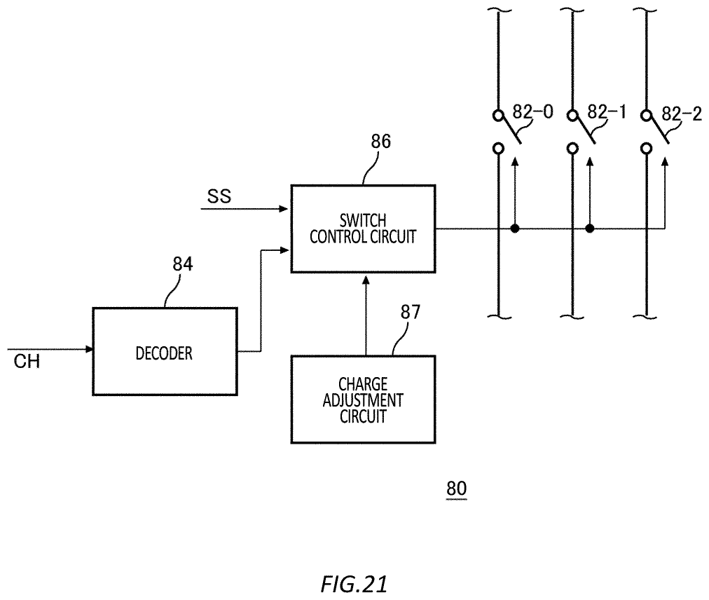

FIG. 21 is a diagram showing another configuration example of the switch device 80. The switch device 80 in the present example has a charge adjustment circuit 87. The other structures are similar to those of other examples described in the present specification. The charge adjustment circuit 87 adjusts the charge amount for each charge capacitor 74 by adjusting the period when each switch 82 is on.

In the examples in FIG. 1 to FIG. 20, during the scan period when the scan start signal SS exhibits H logic, the switch 82 of the corresponding channel is controlled to be in the ON state. In the present example, the charge amount is adjusted by causing the switch 82 to transition to the OFF state during the scan period and reducing the charge time of the charge capacitor 74. When the light-emitting element 72 emits light multiple times during the scan period, the operations of turning on the switch 82, charging the charge capacitor 74, turning off the switch 82, the light-emitting element 72 emitting light, turning on the switch 82, and so on are repeated depending on the number of light emissions. The charge adjustment circuit 87 may adjust the charge amount for each charge capacitor 74 based on the monitoring result of the analog values in the light-emitting unit 70, as in the electric power source control unit 120. The charge amount of the charge capacitor 74 may be different for each channel.

The period when the charge adjustment circuit 87 controls the switch 82 to be in the ON state may be measured by a counter or the like. In addition, the waveform of the scan start signal SS input to the switch control circuit 86 may be caused to L logic at the timing to turn off the switch 82 and be caused to transition to H logic at the timing to turn on the switch 82.

In another example, the charge adjustment circuit 87 may monitor the voltage of each charge capacitor 74 and, when the voltage of the charge capacitor 74 reaches the set value, control the corresponding switch 82 to switch to the OFF state. When the light emission of the light-emitting element 72 ends, and if there are still the number of light emissions remaining in the scan period, the switch 82 is caused to transition to the ON state to charge the charge capacitor 74 again. Such control can also adjust the charge amount of the charge capacitor 74.

While the embodiments of the present invention have been described, the technical scope of the present invention is not limited to the above-described embodiments. It is apparent to persons skilled in the art that various alterations or improvements can be added to the above-described embodiments. It is also apparent from the claims that the embodiments added with such alterations or improvements can be included in the technical scope of the present invention.

The operations, procedures, steps, and stages or the like of each process performed by an apparatus, system, program, and method shown in the claims, specification, or drawings can be performed in any order as long as the order is not indicated by “prior to,” “before,” or the like and as long as the output from a previous process is not used in a later process. Even if the process flow is described using phrases such as “first” or “next” in the claims, specification, and drawings, it does not necessarily mean that the process must be performed in this order.

1. A ranging device comprising:
a light-emitting unit having a plurality of light-emitting elements which emit light to a target;
a light-receiving unit which receives reflected light from the target; and
a control unit which is configured to be able to communicate with the light-emitting unit and the light-receiving unit and has a storage area,
wherein the control unit is configured to be able to send and/or receive a state signal indicating a state of the light-receiving unit to and/or from the light-receiving unit,
the state signal includes information indicating whether or not the light-receiving unit is in a state where the light-receiving unit can measure the reflected light from the target or information for enabling the light-receiving unit to measure the reflected light,
the storage area stores the state signal,
the control unit outputs, to the light-emitting unit, a channel select signal for selecting which of the plurality of light-emitting elements is to emit light and a light emission control signal for controlling a light emission timing of the light-emitting unit in response to the state signal stored in the storage area, and
the light-emitting unit is configured to receive the state signal as input from the light-receiving unit or the control unit.

2. The ranging device according to claim 1, wherein the light-emitting unit is driven in response to the state signal which is input being information indicating that the light-receiving unit is in a state where the light-receiving unit can measure the reflected light from the target or information for enabling the light-receiving unit to measure the reflected light.

3. The ranging device according to claim 2, wherein the control unit:
outputs the light emission control signal to the light-emitting unit and stop outputting the channel select signal to the light-emitting unit in response to the state signal stored in the storage area being information indicating that the light-receiving unit is in a state where the light-receiving unit can measure the reflected light from the target or information for enabling the light-receiving unit to measure the reflected light, and
outputs the channel select signal to the light-emitting unit and stop outputting the light emission control signal to the light-emitting unit in response to the state signal stored in the storage area being different from both information indicating that the light-receiving unit is in a state where the light-receiving unit can measure the reflected light from the target and information for enabling the light-receiving unit to measure the reflected light.

4. The ranging device according to claim 1, wherein the light-receiving unit has:
a light-receiving element which measures the reflected light from the target; and
a state control circuit which generates a scan start signal for controlling the light-receiving element, and
wherein the state control circuit inputs the scan start signal to the control unit as the state signal.

5. The ranging device according to claim 2, wherein the light-receiving unit has:
a light-receiving element which measures the reflected light from the target; and
a state control circuit which generates a scan start signal for controlling the light-receiving element, and
wherein the state control circuit inputs the scan start signal to the control unit as the state signal.

6. The ranging device according to claim 3, wherein the light-receiving unit has:
a light-receiving element which measures the reflected light from the target; and
a state control circuit which generates a scan start signal for controlling the light-receiving element, and
wherein the state control circuit inputs the scan start signal to the control unit as the state signal.

7. The ranging device according to claim 1, wherein the control unit inputs, to the light-receiving unit, a scan start signal for controlling the light-receiving unit to switch to a state where the light-receiving unit can measure the reflected light from the target, as the state signal, and generate the channel select signal based on the scan start signal.

8. The ranging device according to claim 2, wherein the control unit inputs, to the light-receiving unit, a scan start signal for controlling the light-receiving unit to switch to a state where the light-receiving unit can measure the reflected light from the target, as the state signal, and generate the channel select signal based on the scan start signal.

9. The ranging device according to claim 1, wherein the control unit generates, synchronously with the channel select signal, a light emission pulse signal which is supplied to a light-emitting element, being identical to each of the plurality of light-emitting elements, selected by the channel select signal among the plurality of light-emitting elements.

10. The ranging device according to claim 9, wherein the control unit generates the light emission pulse signal based on adjustment information for at least one of a light emission delay time, light emission intensity, or light emission pulse width of the light-emitting element for each channel.

11. The ranging device according to claim 1,
wherein the light-receiving unit inputs the state signal to the light-emitting unit and the control unit, and
the light-emitting unit receives the state signal from the light-receiving unit and receives the channel select signal from the control unit.

12. The ranging device according to claim 1, wherein the control unit synchronously inputs the state signal and the channel select signal to the light-emitting unit.

13. The ranging device according to claim 9, wherein the control unit has:
a channel control circuit which generates the channel select signal; and
a pulse generation circuit which generates the light emission pulse signal.

14. The ranging device according to claim 13, wherein the channel control circuit and the pulse generation circuit are formed on a single chip.

15. The ranging device according to claim 1, wherein the control unit further has a driver which is provided in common for the plurality of light-emitting elements and causes any of the plurality of light-emitting elements to emit light based on a light emission pulse signal corresponding to the light emission control signal,
the light-emitting unit has a plurality of switches provided to correspond to the plurality of light-emitting elements, a plurality of charge capacitors provided to correspond to the plurality of light-emitting elements, and a switch control circuit which controls the plurality of switches,
among the plurality of switches, a switch selected by the channel select signal is controlled to switch to an ON state,
among the plurality of charge capacitors, a charge capacitor corresponding to the switch controlled to switch to the ON state is charged,
among the plurality of light-emitting elements, a light-emitting element corresponding to the charge capacitor which has been charged emits light in response to the light emission pulse signal, and
the switch control circuit detects an end timing of light emission from any of the light-emitting elements, controls, based on the end timing, the switch corresponding to the light-emitting element which is to emit light next to switch to the ON state, and precharges a corresponding charge capacitor, being identical to each of the plurality of charge capacitors.

16. The ranging device according to claim 15, wherein the light-receiving unit repeats a state where the light-receiving unit can measure the reflected light from the target and a state where the light-receiving unit cannot measure the reflected light, and
the switch control circuit controls the switch corresponding to the light-emitting element that is to emit light next to switch to the ON state after the end timing is detected and before the light-receiving unit next switches to a state where the light-receiving unit can measure the reflected light.

17. The ranging device according to claim 16, wherein the switch control circuit detects the end timing based on the state signal.

18. The ranging device according to claim 17, wherein the switch control circuit detects the end timing based on the light emission control signal.

19. A switch device used for a light-emitting unit, in a ranging device, having a plurality of light-emitting elements which emit light to a target and a plurality of charge capacitors, comprising:
a plurality of switches provided to correspond to the plurality of light-emitting elements; and
a switch control circuit which controls the plurality of switches,
wherein, among the plurality of switches, a switch corresponding to a light-emitting element that is to emit light in response to an input channel select signal is controlled to switch to an ON state,
among the plurality of charge capacitors, a charge capacitor corresponding to the switch controlled to switch to the ON state is charged,
among the plurality of light-emitting elements, a light-emitting element corresponding to the charge capacitor that has been charged emits light in response to an input light emission pulse signal, and
the switch control circuit detects an end timing of light emission from any of the light-emitting elements, control, based on the end timing, the switch corresponding to the light-emitting element which is to emit light next to the ON state, and precharge a corresponding charge capacitor, being identical to each of the plurality of charge capacitors.

20. A control chip used for a ranging device, comprising a light-emitting unit having a plurality of light-emitting elements which emit light to a target and a light-receiving unit which receives reflected light from the target, comprising:
a channel control circuit which generates a channel select signal for selecting a light-emitting element that is to emit light; and
a pulse generation circuit which synchronizes a light emission pulse signal which is supplied to the light-emitting element selected by the channel select signal with the channel select signal and generate a light emission pulse signal based on adjustment information for at least one of a light emission delay time, a light emission intensity, or a light emission pulse width of the light-emitting element for each channel.
